(19) United States
(12) Patent Application Publication
(10) Pub. No.: US 2008/0273017 A1
(43) Pub. Date: Nov. 6, 2008

(54) TOUCHPAD USING A COMBINATION OF TOUCHDOWN AND RADIAL MOVEMENTS TO PROVIDE CONTROL SIGNALS

(76) Inventors: Richard D. Woolley, Orem, UT (US); Don T. Saxby, Salt Lake City, UT (US)

Correspondence Address: MORRISS OBRYANT COMPAGNI, P.C., 734 EAST 200 SOUTH, SALT LAKE CITY, UT, 84102, US

(21) Appl. No.: 12/115,406

(22) Filed: May 5, 2008

Related U.S. Application Data
(60) Provisional application No. 60/915,998, filed on May 4, 2007.

(51) Int. Cl. G06F 3/041

(52) U.S. Cl. 345/173

(57) ABSTRACT

A physical or virtual circular touchpad that may have an active touch-sensitive surface in a center area of the touchpad, wherein touchdown in the center area is detected by the touchpad having an active touch-sensitive surface, and then radial movement from the center area towards a perimeter of the circular touchpad and in a specific direction will cause a change in the value of a control parameter.

### CROSS REFERENCE TO RELATED APPLICATIONS

This document claims priority to and incorporates by reference all of the subject matter included in the provisional patent application docket number 3856.CIRQ.PR, having Ser. No. 60/915,998 and filed on May 4, 2007.

### BACKGROUND OF THE INVENTION

1. Field of the Invention

This invention relates generally to the use of a touchpad to generate commands using gestures. More specifically, the present invention is a touchpad having any desired physical or virtual shape, wherein when touchdown is detected in a specific location, a dragging motion from the specific location and proceeding outwards to a perimeter of the touchpad will increase or decrease the value of a variable.

2. Description of Related Art

Touchpad technology of CIRQUE® Corporation can be adapted as described later in this document to perform the desired functions of the present invention. An understanding of CIRQUE® Corporation technology is useful as a primer on the operation of touchpads.

The CIRQUE® Corporation touchpad is a mutual capacitance-sensing device and an example is illustrated in FIG. 1. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

Having described touchpad technologies, it is possible to turn to the application of these technologies. Many mobile and stationary devices are now using touchpad technologies as a means for generating signals that control variables, or as a means for controlling operation of an associated device. Some devices, such as music playing devices, uses a round “wheel” touchpad interface for scrolling through lists and controlling volume, among other things.

Wheel or circular touchpads have exclusively been used in a circular mode of operation. In other words, an operator moves a pointing object such as a finger in a circular motion around a center of the touchpad. The circular touchpad is generally a donut shape, with no touchpad capability in the center. This central hole is typically reserved for a simple mechanical switch.

It would be an advantage over the state of the art in circular touchpads to provide a new method for entering data or for controlling operation of a device that is not limited to moving in a circular motion.

### BRIEF SUMMARY OF THE INVENTION

In a preferred embodiment, the present invention is a physical or virtual circular touchpad that may have an active touch-sensitive surface in a center area of the touchpad, wherein touchdown in the center area is detected by the touchpad having an active touch-sensitive surface, and then radial movement from the center area towards a perimeter of the circular touchpad and in a specific direction will cause a change in the value of a control parameter.

In a first aspect of the invention, the circular touchpad is a virtual touchpad that is imposed on a typical non-circular touchpad.

In a second aspect of the invention, the circular touchpad is implemented in a physically circular design.

In a third aspect of the invention, any shape can be used to implement the touchpad of the present invention, wherein one or more specific areas are provided for detection, and then movement outside the touchdown area will cause the desired increase or decrease in a variable.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective diagram of the components of a capacitance-sensitive touchpad as made by CIRQUE® Corporation.

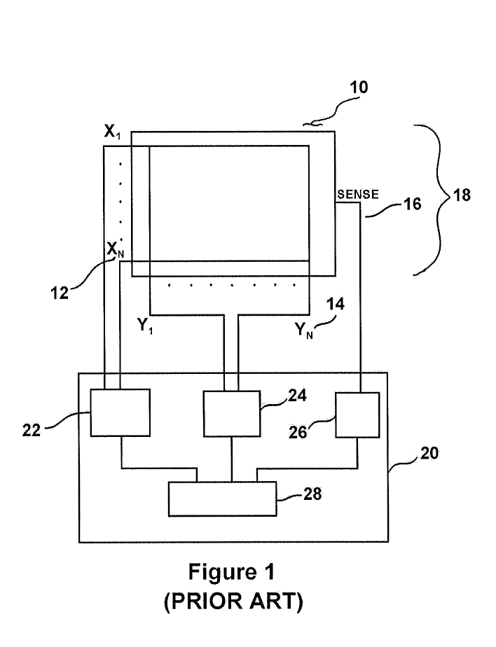

FIG. 2 is a top view of a physically circular touchpad that has an active sensing area in the center of the touchpad.

FIG. 3 is a top view of a circular touchpad that is ring-shaped, having no touch-sensitive central area.

FIG. 4 is a top view of a circular touchpad having an active center area.

FIG. 5 is a touchpad in the shape of a ring with no sensor disposed in the center area.

FIG. 6 is a top view of a virtual circular touchpad disposed within the boundaries of a non-circular touchpad.

FIG. 7 is a top view of a circular touchpad having controls for increasing and decreasing volume and increasing and decreasing a zoom feature.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

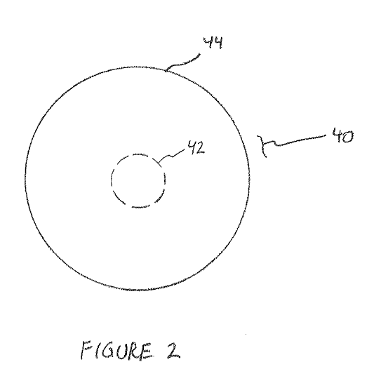

The presently preferred first embodiment of the invention is shown in FIG. 2 as a physically circular touchpad 40, wherein the X and Y electrode grid is laid out in a physically rectangular or circular design that includes a center area that is also part of the touch-sensitive surface of the circular touchpad 40. The specific touchpad technology used to implement the touchpad is not critical, and any suitable touchpad technology can be used. What is important is that the circular touchpad 40 does not have any areas, such as a central area 42, that are inactive. The entire surface of the circular touchpad 40 is capable of detecting a pointing object thereon.

Alternatively, the physically circular touchpad 40 can be a virtually circular touchpad that is essentially a portion of a physically rectangular or other non-circular touchpad shape.

In this first embodiment, the pointing object such as a finger or other conductive object, makes touchdown (the first contact) with the circular touchpad 40 in a center area 42. This center area 42 can be centered on the geometrical center of the circular touchpad 40, or can be offset by some desired distance.

It is likely that the center of the touchpad 40 is the most logical location for touchdown so that the pointing object can move an equal distance in all directions until making contact with the perimeter of the touchpad. In this way, the magnitude of the value of a variable being controlled by movement from the center area 42 to the perimeter can be changed equally no matter what direction the pointing object moves.

For this first embodiment, the center area 42 which is indicated generally as being within the dotted circle, is the area in which touchdown will occur. The actual size of the center area 42 can be selected to be any appropriate size.

In this first embodiment, once touchdown is detected in center area 42, the specific function to be controlled by the pointing object is not yet determined. What has been determined is that some variable (which is also referred to as a “control parameter”) is going to be changed by either increasing or decreasing its value. The function or operation to be controlled by changing the value of the variable is determined by a next move of the pointing object that is on the touchpad 40. Accordingly, without lifting the pointing object off the center area 42, the pointing object is moved out of the center area and toward a perimeter 44 of the touchpad 40.

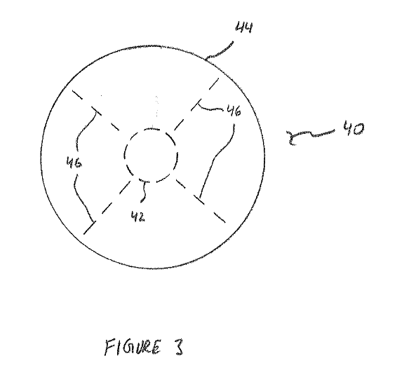

The direction of travel of the pointing object when it leaves the center area 42 determines which control parameter will be increased or decreased. FIG. 3 is provided as an illustration of this aspect of the invention. The circular touchpad 40 is shown as being functionally divided into four quadrants by the dotted lines 46. The dotted lines 46 may be replaced by visible lines, or some other visual cue as to the location of the different quadrants. For example, an overlay can put different colors in the various quadrants. Similarly, physical boundaries might also be used between quadrants such as small ridges. Alternatively, different textures can be disposed in the different quadrants on the surface of the circular touchpad 40.

It should be understood that the number of function quadrants that can be assigned to the circular touchpad 40 is not limited to four. This number was arbitrarily selected as an example. A greater number or a fewer number of sections can be assigned to the circular touchpad 40. The function quadrants can also be reassigned as desired or on-the-fly. Thus, in a first mode, the quadrants can be assigned to volume control. In a second mode of operation, the quadrants can be re-assigned to a different function, such as contrast and brightness controls, scrolling or zooming. The various modes might be listed in the quadrants as a visual cue to the operator.

As the pointing object moves toward the perimeter 44 of the circular touchpad 40, the control parameter is increased or decreased. When the pointing object stops movement, the control parameter also stops increasing or decreasing. If the pointing object is again moved in the direction of the perimeter 44 without having lifted the pointing object, then the control parameter will continue to be increased or decreased. Likewise, moving the pointing object back toward the center area 42 will cause an opposite change in the control parameter. Thus, if moving toward the perimeter 44 caused a decreasing the control parameter, then stopping the pointing object and moving back toward the center area 42 will cause the control parameter to increase.

Alternatively, once a control parameter is being increased or decreased when moving toward the perimeter 44, the control parameter is not changed by moving the pointing object back towards the center area 42. Thus, only movement toward the perimeter 44 causes a change in the control parameter.

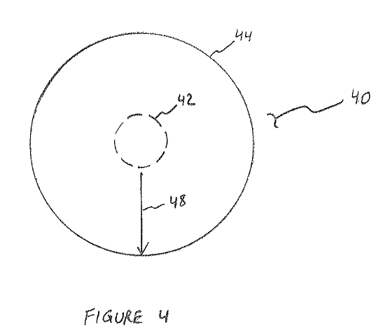

This concept is illustrated in FIG. 4. A touchpad 40 has an active center area 42. Arrow 48 indicates the initial direction of a pointing object on the touchpad 40. When the pointing object moves in the path of arrow 48, the control parameter is being increased or decreased, depending on the choice of the system designer. For example, we will assume that the control parameter being controlled in the quadrant where arrow 48 is located is a decrease in volume on a portable electronic device.

It will be assumed that the pointing object followed the path of arrow 48 to the perimeter 44 of the touchpad 40. Without lifting the pointing object, it was then moved backwards along the path of arrow 48 towards the center area 42. When moving toward the perimeter 44, the volume was decreasing. When moving backwards toward the center area 42, the volume does not change.

In a continuation of this concept, after the pointing object slides back toward the center area 42 it is again stopped, but without lifting the pointing object off the touchpad 40. The pointing object is again moved back toward the perimeter 44 to further decrease the volume control parameter. Thus a back and forth motion of the pointing object would continually decrease the control parameter of volume (or whichever function is being controlled along the path of arrow 48) without having to lift the pointing object off the circular touchpad 40 and start over by making touchdown again in the center area 42.

In contrast, the control parameter will immediately perform the opposite function of the control parameter when the pointing object moves back towards the center area 42 after first moving toward the perimeter 44. Thus, referring to the example shown in FIG. 4, if the pointing object is moved toward the perimeter 44, and then the pointing object is moved back to the center area 42, the control parameter would have the same value as if it had never been changed. Thus, moving along arrow 48 toward the perimeter 44 would decrease volume, but moving along arrow 48 back toward the center area 42 would cause the volume to increase.

It should be remembered that the volume function and the position of the volume control parameter on the touchpad 40 was arbitrarily selected for these examples. Functions can be assigned to any desired quadrant or portion of the touchpad 40. The assignment of functions is controlled in firmware associated with the touchpad circuitry.

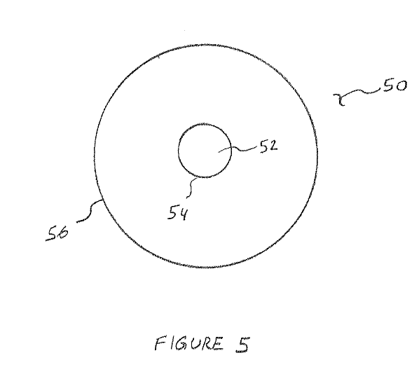

In a second embodiment of a circular touchpad 50 as shown in FIG. 5, a center area 52 is not an active portion of the circular touchpad. In other words, a physical hole is disposed in the center area 52 to eliminate the sensors that are present in FIG. 4, with the circular touchpad 50 having a ring-shaped design. However, operation of the circular touchpad 50 is essentially the same as in the first embodiment as described in FIGS. 2, 3 and 4. Movement of a pointing object from an inner perimeter 54 to an outer perimeter 56 causes the control parameter to be increased or decreased (depending on how it was designed). As in FIG. 4, the value of the control parameter can remain static when moving from the outer perimeter 56 towards the inner perimeter 54, or the value can change in a manner that is opposite to the change that occurs when moving from the inner perimeter to the outer perimeter.

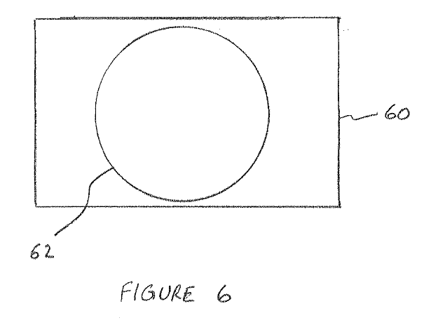

FIG. 6 is provided as a top view of a rectangular touchpad 60 as is commonly found in the art. However, a circular area is shown as an active area that defines a circular touchpad 62. Thus, the circular touchpad 62 is disposed virtually on a rectangular touchpad 60. It should be understood that the actual physical shape of the touchpad is arbitrary. What is important is that any desired touchpad shape can be imposed “virtually” on the physical touchpad to obtain a desired shape for the input of control parameters.

It should be understood that the touchpad can be implemented using different touchpad technologies, including pressure sensing, infra-red, optical, and other touchpad technologies that enable determination of the location of an object that is touching or in proximity to a surface of the touchpad.

Another aspect of the invention is that the physical and virtual circular touchpad can be a general purpose touchpads capable of performing other common touchpad functions such as cursor control, etc. Thus, the touchpad can perform multiple functions by switching modes of operation, or it can be dedicated to changing control parameters.

One method of switching modes can be touchdown of the pointing object in the center area 42 of the touchpad 40 as shown in FIG. 4. Touchdown can switch the operational mode of the touchpad so that subsequent movements across the touchpad 40 will cause a change in the control parameter(s). Alternatively, the mode switch can be a switch that is separate from the touchpad 40, or it can be made in software according to the context of what application is running on the electronic device that is incorporating the touchpad 40.

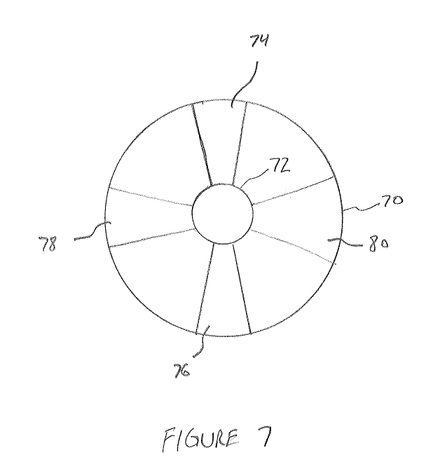

FIG. 7 is a final example of how a circular touchpad might be designed to operate using the principles of the present invention. FIG. 7 shows a circular touchpad 70 having four regions 74, 76, 78, 80 that are used for changing a control parameter. The center area 72 can be a mode switch to activate the control parameter regions. For example, volume is controlled by the regions 74 and 76, wherein region 74 is dedicated to causing an increase in volume and region 76 is dedicated to causing a decrease in volume of an attached electrical device. Touchdown in the center area 72 activates the regions 74, 76, 78, 80. Movement of the pointing object from the center area 72 to an outer perimeter of region 74 causes an increase in volume. Sliding the pointing object back toward the center area 72 without lifting the pointing object can either make no change in volume or decrease the volume. Lifting the pointing object will cause no change to the volume.

Similarly, any other desired feature of the electronic device can be controlled by suing the dedicated regions 78 and 80. For example, region 80 might cause an increase in a zoom feature on an associated display screen, and region 78 can cause a decrease in a zoom feature on the associated display screen.

It is another aspect of the invention that more than one function can be assigned to a single region. By providing multiple modes of operation, region 74 which increases volume might also increase zoom, enable scrolling in a particular direction, etc.

The means for transforming movement of the pointing object on the touchpad to the changing of a value of a control parameter is through firmware associated with the touchpad, and is understood by those skilled in the art. Using firmware makes it relatively quick to update and add new functionality to the present invention. Firmware also makes it possible to switch between different modes of operation of the touchpad. Firmware also makes it possible to enable more than one control parameter to be assigned to the same region of the touchpad, depending upon the mode in which the touchpad is operating.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for changing at least one control parameter by using a touchpad, said method comprising the steps of:
1) providing a circular touchpad that is capable of detecting and tracking movement of a pointing object along a surface thereof, wherein the touchpad has at least one region that controls input for at least one control parameter;
2) performing touchdown of a pointing object in a center area of the touchpad; and
3) moving the pointing object from the center area towards an outer perimeter of the at least one region to thereby change the at least one control parameter.

2. The method as defined in claim 1 wherein the step of providing the circular touchpad further comprises the step of providing a physically circular touchpad.

3. The method as defined in claim 1 wherein the step of providing the circular touchpad further comprises the step of providing a virtually circular touchpad disposed within the boundaries of a non-circular touchpad.

4. The method as defined in claim 1 wherein the method further comprises the step of using a general purpose circular touchpad, wherein the circular touchpad provides means for switching modes of operation between general purpose touch pad functions and manipulation of the least one control parameter.

5. The method as defined in claim 4 wherein the method further comprises the step of providing sensors in the center area of the circular touchpad, wherein touchdown in the center area causes the touchpad to change from a general purpose mode of touchpad operation to a mode that enables manipulation of the at least one control parameter.

6. The method as defined in claim 1 wherein the method further comprises the step of dedicating the circular touchpad to manipulation of the at least one control parameter.

7. The method as defined in claim 6 wherein the method further comprises the step of forming the touchpad as a ring wherein the center area is not a touch sensitive area of the touchpad.

8. The method as defined in claim 7 wherein the method further comprises the step of moving the pointing object from an inner perimeter of the touchpad to an outer perimeter of the touchpad to thereby manipulate the at least one control parameter.

9. The method as defined in claim 1 wherein the method further comprises the steps of:
1) moving the pointing object from the center area to the outer perimeter along a first path to thereby change the at least one control parameter;
2) lifting the pointing object from the touchpad and making touchdown in the center area; and
3) repeating steps 1) and 2) in order to continue to manipulate the control parameter in a same manner.

10. The method as defined in claim 1 wherein the method further comprises the steps of:
1) moving the pointing object from the center area to the outer perimeter along a first path to thereby change the at least one control parameter;
2) moving the pointing object from the outer perimeter towards the center area without lifting the pointing object from the circular touchpad, wherein the at least one control parameter does not change when moving towards the center area; and
3) repeating steps 1) and 2) in order to continue to manipulate the control parameter in a same manner.

11. The method as defined in claim 1 wherein the method further comprises the step of moving the pointing object between the center area and the outer perimeter along a first path without lifting the pointing object, wherein movement from the center area towards the outer perimeter will always increase or decrease the at least one control parameter according to a predetermined setting, and wherein movement from the outer perimeter towards the center area will always change the at least one control parameter in a manner that is opposite predetermined setting.

12. A method for increasing or decreasing the value of at least one control parameter by using a touchpad, said method comprising the steps of:
1) providing a circular touchpad that is capable of detecting and tracking movement of a pointing object along a surface thereof, wherein the touchpad has a plurality of regions, each region controlling the value of at least one control parameter, wherein in a first mode of operation the circular touchpad operates in a general purpose mode that performs common touchpad functions, wherein in a second mode of operation the circular touchpad operates in a mode that is dedicated to increasing or decreasing the value of the at least one control parameter;
2) performing touchdown of a pointing object in a center area of the touchpad; and
3) moving the pointing object from the center area towards an outer perimeter of one of the plurality of regions to thereby increase or decrease the at least one control parameter.

13. The method as defined in claim 12 wherein the step of providing the circular touchpad further comprises the step of providing a physically circular touchpad.

14. The method as defined in claim 12 wherein the step of providing the circular touchpad further comprises the step of providing a virtually circular touchpad disposed within the boundaries of a non-circular touchpad.

15. The method as defined in claim 12 wherein the method further comprises the step of providing means for switching modes of operation between general purpose touch pad operation and manipulation of the least one control parameter.

16. The method as defined in claim 15 wherein the method further comprises the step of providing sensors in the center area of the circular touchpad, wherein touchdown in the center area causes the touchpad to change a mode of operation.

17. The method as defined in claim 12 wherein the method further comprises the step of forming the touchpad as a ring wherein the center area is not a touch sensitive area of the touchpad.

18. The method as defined in claim 17 wherein the method further comprises the step of moving the pointing object from an inner perimeter of the circular touchpad to an outer perimeter of the circular touchpad to thereby manipulate the at least one control parameter.

19. The method as defined in claim 12 wherein the method further comprises the steps of:
1) moving the pointing object from the center area to the outer perimeter along a first path to thereby change the at least one control parameter;
2) lifting the pointing object from the touchpad and making touchdown in the center area; and
3) repeating steps 1) and 2) in order to continue to manipulate the control parameter in a same manner.

20. The method as defined in claim 12 wherein the method further comprises the steps of:
1) moving the pointing object from the center area to the outer perimeter along a first path to thereby change the at least one control parameter;
2) moving the pointing object from the outer perimeter towards the center area without lifting the pointing object from the circular touchpad, wherein the at least one control parameter does not change when moving towards the center area; and
3) repeating steps 1) and 2) in order to continue to manipulate the control parameter in a same manner.

21. The method as defined in claim 12 wherein the method further comprises the step of moving the pointing object between the center area and the outer perimeter along a first path without lifting the pointing object, wherein movement from the center area towards the outer perimeter will always increase or decrease the at least one control parameter according to a predetermined setting, and wherein movement from the outer perimeter towards the center area will always change the at least one control parameter in a manner that is opposite predetermined setting.

22. A touchpad for changing at least one control parameter, said touchpad comprised of:
a circular touchpad that is capable of detecting and tracking movement of a pointing object along a surface thereof;
at least one region that controls input for at least one control parameter;
means for tracking movement of a pointing object from a center area of the circular touchpad to an outer perimeter; and
means for changing a value of the at least one control parameter in accordance with firmware that equates movement within the at least one region to the changing of the value of the at least one control parameter.
